(19) United States
(12) Patent Application Publication
(10) Pub. No.: US 2024/0327650 A1
(43) Pub. Date: Oct. 3, 2024

(54) GELS FOR PIPELINE CORROSION MITIGATION

(71) Applicant: SAUDI ARABIAN OIL COMPANY, Dhahran (SA)

(72) Inventors: Abdullah A. ALZAHRANI, Dammam (SA); Faisal M. ALISSA, Dhahran (SA)

(73) Assignee: SAUDI ARABIAN OIL COMPANY, Dhahran (SA)

(21) Appl. No.: 18/191,720

(22) Filed: Mar. 28, 2023

(51) Int. Cl. C09D 5/08; C09D 5/02; C09D 7/61; C09D 7/63; C09D 7/65; C09D 133/02; F16L 58/10

(52) U.S. Cl. CPC C09D 5/086; C09D 5/024; C09D 5/084; C09D 7/61; C09D 7/63; C09D 7/65; C09D 133/02; F16L 58/1072

(57) ABSTRACT

Polymeric gel (e.g., a polymeric gel pack) may be used for protection of a pipeline against damage due to environmental factors such as corrosion. For example, a method of using a polymeric gel for pipeline corrosion mitigation may include: applying a polymeric gel pack including a polymeric gel to a pipeline, wherein a first precursor fluid and a second precursor fluid react to form the polymeric gel, and wherein the polymeric gel pack at least partially surrounds the pipeline.

### FIELD OF THE DISCLOSURE

The present disclosure relates generally to mitigation of pipeline corrosion.

### BACKGROUND OF THE DISCLOSURE

Pipelines are typically used for transporting hydrocarbons, and other fluids, across distance. Operation of a pipeline often involves risk of corrosion in many environments, particularly at marine environments, in rainy environments, or where surrounding earth retains water. Additionally pipelines may be subject to other damage caused by individuals or wildlife. Damage (including corrosion) may reduce operational capability and may require costly remediation or replacement of components of the pipeline.

Current methods of mitigating corrosion of a pipeline may include burying the pipeline in-ground (e.g., sand, earth, and the like). Said burying may be ineffective due to movement of the ground causing pipeline exposure and/or the ground itself retaining moisture leading to corrosion. Other current methods of mitigating corrosion of a pipeline may involve coating pipes before burying in-ground. However, said coatings may require periodic reapplication. Said reapplication may be costly because of the required excavation of portions of the pipeline.

### SUMMARY OF THE DISCLOSURE

Various details of the present disclosure are hereinafter summarized to provide a basic understanding. This summary is not an exhaustive overview of the disclosure and is neither intended to identify certain elements of the disclosure, nor to delineate the scope thereof. Rather, the primary purpose of this summary is to present some concepts of the disclosure in a simplified form prior to the more detailed description that is presented hereinafter.

A nonlimiting method of the present disclosure includes: applying a polymeric gel pack comprising a polymeric gel to a pipeline, wherein a first precursor fluid and a second precursor fluid react to form the polymeric gel, wherein the polymeric gel pack at least partially surrounds the pipeline, wherein the first precursor fluid comprises, by total volume of the first precursor fluid: from 25 vol % to 50 vol % of polyacrylic acid, from 1 vol % to 10 vol % of an oxygen scavenger, from 5 vol % to 15 vol % of a corrosion inhibitor, and a balance of water; and wherein the second precursor fluid comprises, by total volume of the second precursor fluid: from 1 vol % to 10 vol % of an oxygen scavenger, from 5 vol % to 15 vol % of a corrosion inhibitor, from 25 vol % to 60 vol % of a calcium group salt, from 1 vol % to 20 vol % of a copper salt, and a balance of water.

Another nonlimiting method of the present disclosure includes: applying a polymeric gel pack comprising a polymeric gel to a pipeline, wherein a first precursor fluid and a second precursor fluid react to form the polymeric gel, and wherein the polymeric gel pack at least partially surrounds the pipeline.

A nonlimiting system of the present disclosure includes: a pipeline; and a polymeric gel pack comprising a polymeric gel, wherein the polymeric gel pack at least partially surrounds the pipeline, and wherein the polymeric gel comprises polyacrylic acid, wherein the polyacrylic acid has been, at least partially, crosslinked.

Any combinations of the various embodiments and implementations disclosed herein can be used in a further embodiment, consistent with the disclosure. These and other aspects and features can be appreciated from the following description of certain embodiments presented herein in accordance with the disclosure and the accompanying drawings and claims.

### BRIEF DESCRIPTION OF THE DRAWINGS

FIG. 1A shows a diagram of a comparative example system.

FIG. 1B shows a diagram of a nonlimiting example pipeline system according to the present disclosure.

FIG. 2 shows a diagram of another nonlimiting example pipeline system according to the present disclosure.

FIG. 3 shows a profile view of a nonlimiting example pipeline system according to the present disclosure.

### DETAILED DESCRIPTION

Embodiments of the present disclosure will now be described in detail with reference to the accompanying Figures. Like elements in the various figures may be denoted by like reference numerals for consistency. Further, in the following detailed description of embodiments of the present disclosure, numerous specific details are set forth in order to provide a more thorough understanding of the claimed subject matter. However, it will be apparent to one of ordinary skill in the art that the embodiments disclosed herein may be practiced without these specific details. In other instances, well-known features have not been described in detail to avoid unnecessarily complicating the description. Additionally, it will be apparent to one of ordinary skill in the art that the scale of the elements presented in the accompanying Figures may vary without departing from the scope of the present disclosure.

Embodiments in accordance with the present disclosure generally relate to mitigation of pipeline corrosion. More specifically, the present disclosure provides systems and methods for mitigating pipeline corrosion, through the use of a polymeric gel pack. Generally, the polymeric gel pack described herein surrounds at least a portion of the pipeline. The polymeric gel pack may mitigate water ingress to the portions of the pipeline that the polymeric gel pack surrounds. Additionally, the polymeric gel pack may have reduced mobility over conventional sand or earth, allowing the polymeric gel pack to remain immobilized and protect the pipeline from corrosion.

“Corrosion” as used herein refers to deterioration of a material as a result of contact with a degradative species in its surroundings. In the case of the present disclosure, corrosion may include, but is not limited to, water wetting, scale formation, solid accumulation, or any other corrosion method or type known in the art, as well as any combination thereof. It should be noted that methods and systems described herein that mitigate corrosion may additionally mitigate physical damage to pipelines by humans or animals through formation of a barrier that prevents contact with the pipeline.

As used herein when referring to a polymeric gel pack surrounding a component of a pipeline, the terms “surrounds,” “surrounded by,” and the like refer to at least a portion of the polymeric gel pack being located radially outward from the centerline of the pipeline at a location at least partially coplanar to a plane that is perpendicular to the centerline of the pipeline. The polymeric gel may form an arc of any number of circumferential degrees (e.g., a 5° arc to a 360° arc) relative to the centerline of the pipeline. The terms “surrounds,” “surrounded by,” and the like are similarly applied to the containment structure when referring to a containment structure surrounding a polymeric gel pack.

Maintaining corrosion mitigation over time can be important. For traditional paints and coatings, this may mean that costly excavation of below-ground portions of the pipeline need to occur to re-apply said anti-corrosion paints and coatings. However, advantageously, the polymeric gel packs of the present disclosure may be sufficiently sized (e.g., depth, height, radial distance extending from the pipeline, height, and the like) to provide robust water ingress mitigation such that replacement is needed less often, if even needed, thereby reducing or eliminating the excavation costs. For example, the polymeric gel packs of the present disclosure may mitigate ingress of greater than 99 vol % of liquid water from a surface of the polymeric gel pack to an interior of the polymeric gel pack over a period of 30 days.

The polymeric gel pack of the present disclosure may mitigate corrosion in a cost effective manner by directly applying corrosion mitigation to a pipeline, including wherein the pipeline is sprayed so as to apply a polymeric gel and form the polymeric gel pack. Additionally, the polymeric gel pack of the present disclosure may, at least partially, utilize readily available sand to form the polymeric gel pack to mitigate water ingress. For example, methods of the present disclosure may include spraying a sand covering on a pipeline and, then, forming a polymeric gel pack surrounding the sand-covered pipeline, thus providing corrosion mitigation.

The polymeric gel packs of the present disclosure may be located at or above ground level to mitigate water absorbing into the ground area from above. Further, the polymeric gel packs of the present disclosure may also be located at least partially below ground to mitigate water ingress from around the pipeline. The polymeric gel packs of the present disclosure may extend, for example, a decimeter or a half meter or so radially from the pipeline, which may provide a more durable barrier to water ingress than traditional anti-corrosion paints and coatings. The polymeric gel packs of the present disclosure may furthermore comprise a chemical corrosion inhibitor, which may react with the components of the pipeline, the polymeric gel pack, water entering the polymeric gel pack, or any combination thereof to reduce the potential for and extent of corrosion of the pipeline.

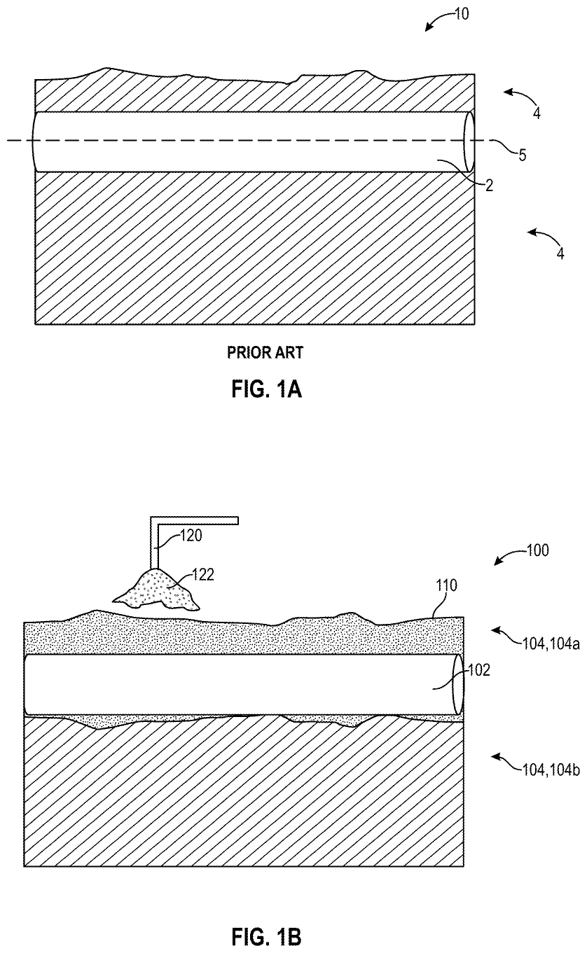

A comparative example system according to the present disclosure is shown in FIG. 1A. System 10 comprises a pipeline 2 in sand 4, with a centerline of the pipeline shown by dashed line 5. Comparative example system 10 does not include a polymeric gel pack, thus potentially exposing the pipeline 2 to corrosion or other damage.

A nonlimiting example system according to the present disclosure is shown in FIG. 1B. System 100 comprises pipeline 102 in sand 104, with the sand comprising an upper portion 104a and a lower portion 104b. The system includes a polymeric gel pack being 110, comprising a polymeric gel and sand. The polymeric gel pack 110 of system 100 may serve to mitigate corrosion and damage to the pipeline 102 by forming a physical barrier. The polymeric gel pack 110 is shown being formed by the sand of the upper portion 104a and a polymeric gel. The system includes sprayer 120, the sprayer 120 providing a mixture 122 of a first precursor fluid and a second precursor fluid, wherein the first precursor fluid and the second precursor fluid react to form the polymeric gel of the polymeric gel pack 110.

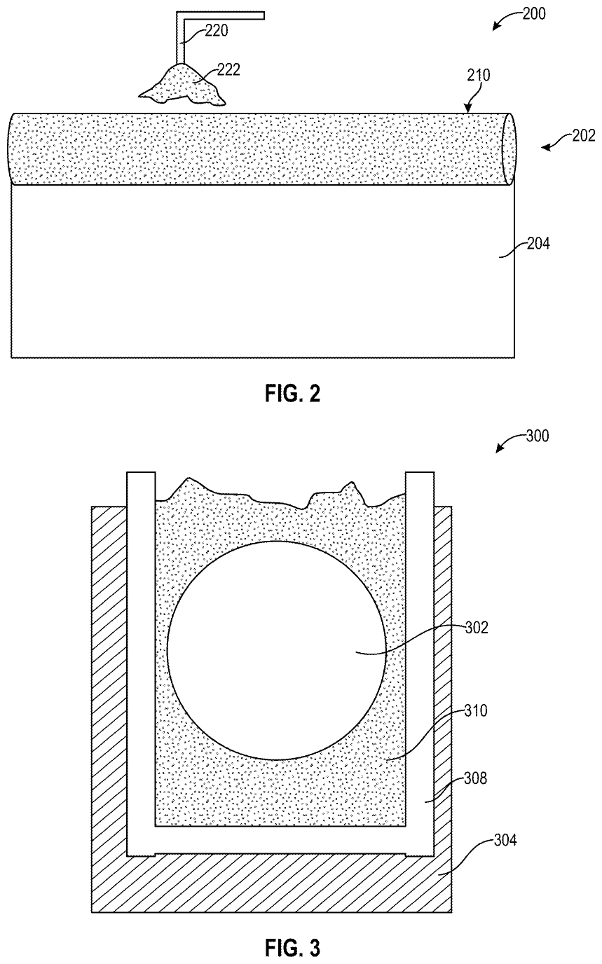

In another nonlimiting example system, shown in FIG. 2, system 200 comprises pipeline 202 in ground 204. The system 200 includes a polymeric gel pack 210 comprising a polymeric gel formed directly on pipeline 202. As shown, the polymeric gel pack is formed as a layer of polymeric gel on pipeline 202. The system 200 includes a sprayer 220, the sprayer 220 providing a mixture 222 of a first precursor fluid and a second precursor fluid, wherein the first precursor fluid and the second precursor fluid react to form the polymeric gel of the polymeric gel pack 210.

It should be noted that the pipeline described herein may comprise any suitable pipeline that is desired to have corrosion mitigated. The pipeline may preferably comprise a steel pipeline. It should additionally be noted that a single polymeric gel pack may mitigate corrosion in one (1) pipeline, or in more than one pipelines (e.g., two (2) or more, or three (3) or more).

### Containment Structure

The systems described herein may comprise a containment structure for the polymeric gel pack. A profile view of a nonlimiting example system that includes a polymeric gel pack with a containment structure is shown in FIG. 3. System 300 includes a pipeline 302 in ground 304 with a polymeric gel pack 310 surrounding the pipeline 302, and a containment structure 308 surrounding the polymeric gel pack 310 so as to contain the polymeric gel pack 310 at the location of the pipeline 302.

As described above, the containment structure may serve to contain the polymeric gel pack at the pipeline. It should be noted that “contain” or “containment” as used herein refers to holding at least a portion (of any size) of a material (e.g., the polymeric gel pack) at a desired location and preventing movement relative to the location. Some movement may occur with the use of a containment structure and a portion of the material (e.g., the polymeric gel pack) may escape out of the containment structure. The containment structure may be located on top of the polymeric gel, below the polymeric gel pack, beside the polymeric gel pack, around the polymeric gel pack, within or between portions of the polymeric gel pack, or any combination thereof. The containment structure may be any suitable shape and size (including any suitable thickness) for containing the polymeric gel pack and may include features such as baffles, netting, pores, and the like, to prevent movement of the polymeric gel pack, to allow for draining of fluids that enter the polymeric gel pack, or any combination thereof.

The containment structure may exist above ground, below ground, at ground level, or any combination thereof. The containment structure may comprise any suitable material for containing the polymeric gel pack including, but not limited to, earth, sand, a rock, a polymer, a metal, wood, concrete, masonry, a fiber, a paper, and the like, or any combination thereof.

### Polymeric Gel Pack

The polymeric gel pack may exist above ground level, below ground level, at ground level, or any combination thereof.

The polymeric gel pack may have any suitable dimensions. Preferably the polymeric gel pack may extend from 0.1 ft to 500 ft, or 0.001 ft to 500 ft, or 1 ft to 100 ft, or 1 ft to 25 ft, or 1 ft to 10 ft, or 1 ft to 5 ft, or 0.1 ft to 5 ft (0.03 m to 152 m, 0.0003 m to 152 m, or 0.3 m to 30 m, or 0.3 m to 7.7 m, or 0.3 m to 3 m, or 0.3 m to 1.5 m, or 0.03 m to 1.5 m) radially from the centerline of the pipeline. The centerline of the pipeline, for the purposes of the present disclosure, may be defined as a largely horizontal central line extending from end to end down the center of the pipeline (for example, as shown by dashed line 105 in FIG. 1A).

Preferably the polymeric gel pack may have a height from 0.1 ft to 25 ft, or 1 ft to 25 ft, or 1 ft to 10 ft, or 1 ft to 5 ft, or 0.1 ft to 5 ft (0.03 m to 7.7 m, or 0.3 m to 7.7 m, or 0.3 m to 3 m, or 0.3 m to 1.5 m, or 0.03 m to 1.5 m). For the purposes of the present disclosure, height of the polymeric gel pack may be defined as from the top of the polymeric gel pack to the bottom of the polymeric gel pack as measured vertically.

Preferably the polymeric gel pack may have a depth from 0.1 ft to 25 ft, or 1 ft to 25 ft, or 1 ft to 10 ft, or 1 ft to 5 ft, or 0.1 ft to 5 ft (0.03 m to 7.7 m, or 0.3 m to 7.7 m, or 0.3 m to 3 m, or 0.3 m to 1.5 m, or 0.03 m to 1.5 m). For the purposes of the present disclosure, depth of the polymeric gel pack may be defined as from ground level to the bottom of the polymeric gel pack as measured vertically.

The polymeric gel pack may have any length suitable for providing corrosion mitigation to the pipeline(s) to which the polymeric gel pack is applied.

The polymeric gel pack may have any suitable shape. The polymeric sand pack may be partitioned into two or more portions, which may or may not be in direct contact with other portions.

It should be noted that the shape and dimensions of the polymeric gel pack may be restricted by a component of the pipeline, by surrounding equipment, by the features of the surrounding geological environment, and the like, or any combination thereof. As a nonlimiting example, the polymeric gel pack may rest on and be supported from below by the ground surrounding the pipeline.

A polymeric gel pack according to the present disclosure may comprise a polymeric gel, and optionally, sand. When sand is included, the polymeric gel pack may comprise from 10 wt % to 99 wt % (or 10 wt % to 90 wt %, or 10 wt % to 75 wt %, or 10 wt % to 50 wt %, or 10 wt % to 25 wt %, or 50 wt % to 99 wt %, or 50 wt % to 90 wt %) of a polymeric gel and a balance of sand, by weight of the polymeric gel pack.

Sand may include minerals that include, but are not limited to, silicon dioxide, aluminosilicate, magnesium silicate, and the like, or any combination thereof.

The sand may preferably comprise a plurality of particles, which may have an average (mean) particle size from 0.1 mm to 0.5 mm (or less than 6 mm, or less than 2 mm, or from to 0.002 mm to 2 mm, or from 0.02 mm to 2 mm, or from 0.2 mm to 2 mm, or from 0.6 mm to 2 mm, or from 0.125 mm to 1 mm) as measured by ISO 14688-1:2017.

### Polymeric Gel

The polymeric gel may comprise, at least partially, crosslinked polyacrylic acid (e.g., polyacrylic acid crosslinked with one or more salts (e.g., the calcium group salt, the copper salt)), an oxygen scavenger, a corrosion inhibitor, a calcium group salt, and a copper salt. The polymeric gel may, optionally, further comprise a viscosity enhancer. The calcium group salt, the copper salt, or any combination thereof, may provide structure to the polymeric gel through supporting crosslinking of the polyacrylic acid. The optional viscosity enhancer, if present, may additionally provide structure to the polymeric gel.

The polyacrylic acid may be present in the polymeric gel at a concentration, by total weight of the polymeric gel, from 20 wt % to 95 wt % (or 20 wt % to 90 wt %, or 50 wt % to 95 wt %, or 50 wt % to 90 wt %). The oxygen scavenger may be present in the polymeric gel, by total weight of the polymeric gel, at a concentration from 0.5 wt % to 20 wt % (or 1 wt % to 20 wt %, or 1 wt % to 10 wt %, or 5 wt % to 15 wt %). The corrosion inhibitor may be present in the polymeric gel, by total weight of the polymeric gel, at a concentration from 0.5 wt % to 20 wt % (or 1 wt % to 20 wt %, or 1 wt % to 10 wt %, or 5 wt % to 15 wt %). The calcium group salt may be present in the polymeric gel, by total weight of the polymeric gel, at a concentration from 0.5 wt % to 40 wt % (or 1 wt % to 40 wt %, or 10 wt % to 40 wt %, or 10 wt % to 30 wt %). The copper salt may be present in the polymeric gel, by total weight of the polymeric gel, at a concentration from 0.5 wt % to 20 wt % (or 1 wt % to 20 wt %, or 1 wt % to 10 wt %, or 5 wt % to 15 wt %). The optional viscosity enhancer may be present in the polymeric gel, by total weight of the polymeric gel, at a concentration from 0.5 wt % to 20 wt % (or 1 wt % to 20 wt %, or 1 wt % to 10 wt %, or 5 wt % to 15 wt %).

The polymeric gel described herein may be formed from the combination of two precursor fluids. The two precursor fluids may be combined at a volumetric ratio of the first precursor fluid to the second precursor fluid or from 1:10 to 10:1 (or 1:8 to 8:1, or 1:5 to 5:1). The two precursor fluid

The first precursor fluid of the two precursor fluids may comprise polyacrylic acid, an oxygen scavenger, a corrosion inhibitor, and, optionally, a viscosity enhancer. Additionally the first precursor fluid may comprise a balance of aqueous fluid.

The first precursor fluid may comprise, by volume of the first precursor fluid, from 20 vol % to 60 vol % (or 25 vol % to 50 vol %, or 30 vol % to 50 vol %, or 33 vol % to 49 vol %, or 32 vol % to 34 vol %, or 48 vol % to 50 vol %) of polyacrylic acid. The polyacrylic acid may be provided as an aqueous solution with a concentration from 1.0 mol/L to saturated (or 1 wt % to 35 wt %, or 5 wt % to 35 wt %, or 5 wt % to 30 wt %, or 10 wt % to 30 wt %, or 25 wt % to 35 wt %, or about 25 wt %). “Saturated,” as used in the present disclosure refers to a concentration of a solution in which the maximum amount of solvent is dissolved at atmospheric pressure and 25° C. It should be noted that use of polyacrylic acid may, in some instances, allow for dissolving of the polymeric gel pack using an acid (e.g. hydrochloric acid, tetrasodium glutamate diacetate (GLDA), acetic acid, and the like, or any combination thereof) for purposes of maintenance, inspection, and the like.

The first precursor fluid may further comprise, by volume of the first precursor fluid, from 1 vol % to 10 vol % (or 1 vol % to 8 vol %, or 1 vol % to 5 vol %, or 3 vol % to 8 vol %, or 3 vol % to 5 vol %) of an oxygen scavenger. The oxygen scavenger may be provided as an aqueous solution with a concentration from 1.0 mol/L to saturated (or 1 wt % to 30 wt %, or 1 wt % to 25 wt %, or 3 wt % to 25 wt %, or 3 wt % to 20 wt %, or 1 wt % to 20 wt %). Examples of oxygen scavengers may include, but are not limited to, sodium sulfite, cobalt sulfate, sodium bisulfite, hydrazine, carbohydrazide, and the like, or any combination thereof. Suitable oxygen scavengers include OXYGON™ (organic oxygen scavenger, available from Norchem or Halliburton).

The first precursor fluid may further comprise, by volume of the first precursor fluid, from 1 vol % to 20 vol % (or 5 vol % to 15 vol %, or 8 vol % to 12 vol %, or 10 vol %) of a corrosion inhibitor. The corrosion inhibitor may be provided as an aqueous solution with a concentration from 1.0 mol/L to saturated (or 1 wt % to 70 wt %, or 20 wt % to 70 wt %, or 30 wt % to 70 wt %, or 40 wt % to 60 wt %, or 40 wt % to 55 wt %, or 45 wt % to 60 wt %, or 45 wt % to 55 wt %, or about 50 wt %). Examples of corrosion inhibitors may include, but are not limited to, a quaternary ammonium compound, alkyldimethylbenzylammonium chloride, ammonium bisulfite, an alcohol (e.g., (2-methoxymethylethoxy)-propanol), and the like, or any combination thereof. Suitable corrosion inhibitors include HYDROSURE™ O-3670R (a mixture of quaternary ammonium compounds and ammonium hydrogen sulfite, available from ChampionX).

The first precursor fluid may further comprise, by volume of the first precursor fluid, from 1 vol % to 10 vol % (or 1 vol % to 8 vol %, or 1 vol % to 5 vol %, or 3 vol % to 8 vol %, or 3 vol % to 5 vol %, or 5 vol % to 7 vol %, or 4 vol % to 8 vol %) of a viscosity enhancer. The viscosity enhancer may be provided as an aqueous solution with a concentration from 1.0 mol/L to saturated (or 1 wt % to 35 wt %, or 1 wt % to 30 wt %, or 3 wt % to 25 wt %, or 5 wt % to 25 wt %, or 5 wt % to 22 wt %, or 5 wt % to 20 wt %, or 8 wt % to 22 wt %). Examples of viscosity enhancers may include, but are not limited to, a polymer (e.g., carboxymethyl hydroxypropyl guar (CMHPG), hydroxypropyl guar (HPG), carboxymethylhydroxypropyl guar (CMHPG), guar, carboxymethyl guar (CMG), derivatized guar, carboxymethyl cellulose, carboxymethyl hydroxyl propyl cellulose, cellulose derivatives), and the like, or any combination thereof.

The first precursor fluid may further comprise a balance quantity of an aqueous fluid. Any of the aqueous fluids described within the present disclosure may comprise any suitable aqueous fluid including, but not limited to, water, brine, saltwater, produced water, fresh water, and the like, or any combination thereof.

The first precursor fluid may, furthermore, be adjusted to have a pH from 5.0 to 9.5 (or 5.1 to 9.1, or 5.1 to 8.0, or 8.0 to 9.1). pH adjustment may comprise addition of any suitable basic compound, including but not limited to, for example, sodium hydroxide, sodium carbonate, and the like, or any combination thereof.

The second precursor fluid of the two precursor fluids may comprise a corrosion inhibitor, a calcium group salt, a copper salt, and an oxygen scavenger. Additionally, the second precursor fluid may comprise a balance of aqueous fluid.

The second precursor fluid may further comprise, by volume of the second precursor fluid, from 1 vol % to 20 vol % (or 5 vol % to 15 vol %, or 8 vol % to 12 vol %, or 10 vol %) a corrosion inhibitor. Examples of corrosion inhibitors are described above.

The second precursor fluid may comprise from 20 vol % to 60 vol % 0 (or 20 vol % to 50 vol %, or 30 vol % to 50 vol %, or 33 vol % to 49 vol %, or 33 vol % to 40 vol %, or 40 vol % to 50 vol %) of a calcium group salt. The calcium group salt may be provided as an aqueous solution with a concentration from 1.0 mol/L to saturated (or 10 wt % to 50 wt %, or 20 wt % to 60 wt %, or 10 wt % to 60 wt %, or 20 wt % to 50 wt %, or 25 wt % to 55 wt %, or 30 wt % to 50 wt %, or 33 wt % to 50 wt %, or 33 wt % to 49 wt %, or 30 wt % to 39 wt %). Example calcium group salts may include, but are not limited to, calcium chloride, calcium bromide, calcium iodide, magnesium chloride, and the like, or any combination thereof. As discussed above, the calcium group salt may support crosslinking of the polyacrylic acid in the polymeric gel.

The second precursor fluid may further comprise from 1 vol % to 30 vol % (or 1 vol % to 20 vol %, or 2 vol % to 20 vol %, or 2 vol % to 17 vol %, or 5 vol % to 17 vol %, or 10 vol % to 20 vol %) of a copper salt. The copper salt may be provided as an aqueous solution with a concentration from 1.0 mol/L to saturated (or 1 wt % to 25 wt %, or 1 wt % to 25 wt %, or 2 wt % to 25 wt %, or 2 wt % to 20 wt %, or 2 wt % to 17 wt %, or 1 wt % to 17 wt %). Example copper salts may include, but are not limited to, copper(II) chloride, copper(II) sulfate, copper(II) nitrate, and the like, or any combination thereof. The copper salt may, optionally, include a counter ion such as for example, sodium hydroxide. As discussed above, the copper salt may support crosslinking of the polyacrylic acid in the polymeric gel. It should be noted that, without being bound by theory, the copper salt may cause the polymeric gel to have a color (e.g., a blue color), so as to indicate the presence of a polymeric gel.

The second precursor fluid may further comprise, by volume of the second precursor fluid, from 1 vol % to 10 vol % (or 1 vol % to 8 vol %, or 1 vol % to 5 vol %, or 3 vol % to 8 vol %, or 3 vol % to 5 vol %) of an oxygen scavenger. Examples of oxygen scavengers are described above.

The second precursor fluid may further comprise a balance quantity of an aqueous fluid. Examples of suitable aqueous fluids are described above.

In addition to the above described components, the precursor fluids (e.g., first precursor fluid, second precursor fluid), the polymeric gel, or a combination thereof may each comprise one or more additives. Examples of suitable additives may include, but are not limited to, a pH control agent, an antioxidant, a scale inhibitor, a gel stabilizer, and the like, or any combination thereof. The one or more additives may, if added thereto, be present in the first precursor fluid, the second precursor fluid, or both at a concentration (in each fluid in which the one or more additives are present) of 25 wt % or less (or 10 wt % or less, or 0 wt % to 25 wt %, or 0 wt % to 10 wt %). The one or more additives may, if added thereto, be present in the polymeric gel at a concentration of 25 wt % or less (or 10 wt % or less, or 0 wt % to 25 wt %, or 0 wt % to 10 wt %).

### Application

The first precursor fluid, the second precursor fluid, and the optional sand may be mixed at the above described ratios immediately before application to the pipeline, or may be mixed in situ during application to the pipeline. Without being bound by theory, the combination of the first precursor fluid and second precursor fluid may serve to crosslink the polyacrylic acid within the polymeric gel, so as to form a viscous gel for formation of the polymeric gel pack. As a nonlimiting example, the first precursor fluid and second precursor fluid may be applied by use of a sprayer to sand above the pipeline. As another nonlimiting example, the first precursor fluid may be applied by a sprayer directly to the pipeline, so as to be, at least, partially, in contact with the outer surface of the pipeline, followed by the application, by a sprayer, of the second precursor fluid, thus crosslinking, at least partially, the polyacrylic acid. Any suitable sprayer may be used for application of the first and second precursor fluid, including, but not limited to, a high pressure sprayer, a low pressure sprayer, and the like, or any combination thereof. One skilled in the art should be able to, with the benefit of this disclosure, apply polymeric gel packs of the present disclosure to a pipeline. It should additionally be noted that there may be additional valves, actuators, pumps, temperature sensors, electronic controllers, and the like, that are customarily employed in pipelines or pipeline operations that, for the purpose of simplified schematic illustrations and description, may not be shown or described within the present disclosure.

### Additional Embodiments

Embodiments disclosed herein include:

Embodiment 1. A method comprising: applying a polymeric gel pack comprising a polymeric gel to a pipeline, wherein a first precursor fluid and a second precursor fluid react to form the polymeric gel, wherein the polymeric gel pack at least partially surrounds the pipeline, wherein the first precursor fluid comprises, by total volume of the first precursor fluid: from 25 vol % to 50 vol % of polyacrylic acid, from 1 vol % to 10 vol % of an oxygen scavenger, from 5 vol % to 15 vol % of a corrosion inhibitor, and a balance of water; and wherein the second precursor fluid comprises, by total volume of the second precursor fluid: from 1 vol % to 10 vol % of an oxygen scavenger, from 5 vol % to 15 vol % of a corrosion inhibitor, from 25 vol % to 60 vol % of a calcium group salt, from 1 vol % to 20 vol % of a copper salt, and a balance of water.

Embodiment 2. A method comprising: applying a polymeric gel pack comprising a polymeric gel to a pipeline, wherein a first precursor fluid and a second precursor fluid react to form the polymeric gel, and wherein the polymeric gel pack at least partially surrounds the pipeline.

Embodiment 3. The method of Embodiment 1 or 2, wherein the first precursor fluid and the second precursor fluid are applied to sand surrounding the pipeline.

Embodiment 4. The method of any one of Embodiments 1-3, wherein applying the polymeric gel pack comprises applying the first precursor fluid and the second precursor fluid directly to the pipeline so as to form the polymeric gel pack as a layer on the pipeline.

Embodiment 5. The method of any one of Embodiments 1-4, wherein applying the polymeric gel pack comprises spraying the first precursor fluid and the second precursor fluid surrounding the pipeline.

Embodiment 6. The method of any one of Embodiments 2-5, wherein the first precursor fluid comprises, by total volume of the first precursor fluid: from 25 vol % to 50 vol % of polyacrylic acid, from 1 vol % to 10 vol % of an oxygen scavenger, from 5 vol % to 15 vol % of a corrosion inhibitor, and a balance of water.

Embodiment 7. The method of Embodiment 1 or 6, wherein the oxygen scavenger is provided as a first aqueous solution having a first concentration of the oxygen scavenger from 1.0 mol/L to saturated, and wherein the corrosion inhibitor is provided as a second aqueous solution having a second concentration of the corrosion inhibitor from 1.0 mol/L to saturated.

Embodiment 8. The method of any one of Embodiments 1 or 6-7, wherein the oxygen scavenger comprises sodium sulfite, cobalt sulfate, sodium bisulfite, hydrazine, carbohydrazide, or any combination thereof, or a combination thereof, and wherein the corrosion inhibitor comprises a quaternary ammonium compound, alkyldimethylbenzylammonium chloride, ammonium bisulfite, an alcohol, or any combination thereof.

Embodiment 9. The method of any one of Embodiments 1-8, wherein the first precursor fluid further comprises, by total volume of the first precursor fluid, from 1 vol % to 10 vol %. of a viscosity enhancer.

Embodiment 10. The method of Embodiment 9, wherein the viscosity enhancer comprises a solution of carboxymethyl hydroxypropyl guar (CMHPG), hydroxypropyl guar (HPG), carboxymethylhydroxypropyl guar (CMHPG), guar, carboxymethyl guar (CMG), derivatized guar, carboxymethyl cellulose, carboxymethyl hydroxyl propyl cellulose, cellulose derivatives, or any combination thereof, and wherein a concertation of the viscosity enhancer in the solution is from 1.0 mol/L to saturated.

Embodiment 11. The method of any one of Embodiments 1-10, wherein the first precursor fluid further comprises sodium hydroxide, sodium carbonate, or a combination.

Embodiment 12. The method of any one of Embodiments 1-11, wherein the pH of the first precursor fluid is adjusted to be from 5.1 to 9.1.

Embodiment 13. The method of any one of Embodiments 2-12, wherein the second precursor fluid comprises, by total volume of the second precursor fluid: from 1 vol % to 10 vol % of an oxygen scavenger, from 5 vol % to 15 vol % of a corrosion inhibitor, from 25 vol % to 60 vol % of a calcium group salt, from 1 vol % to 20 vol % of a copper salt, and a balance of water.

Embodiment 14. The method of any one of Embodiments 1-13, wherein the copper salt comprises a solution of copper(II) chloride, copper(II) sulfate, copper(II) nitrate, or any combination thereof, and wherein the solution has a concentration of the copper salt from 1.0 mol/L to saturated.

Embodiment 15. The method of any one of Embodiments 1-14, wherein the calcium group salt comprises a solution of calcium chloride, calcium bromide, calcium iodide, magnesium chloride, or any combination thereof, and wherein the solution has a concentration of the calcium group salt from 1.0 mol/L to saturated.

Embodiment 16. The method of any one of Embodiments 1-15, wherein the polymeric gel pack further comprises sand.

Embodiment 17. A system comprising: a pipeline; and a polymeric gel pack comprising a polymeric gel, wherein the polymeric gel pack at least partially surrounds the pipeline, and wherein the polymeric gel comprises polyacrylic acid, wherein the polyacrylic acid has been, at least partially, crosslinked.

Embodiment 18. The system of Embodiment 17, wherein the polymeric gel comprises, by weight of the polymeric gel: from 20 wt % to 95 wt % of the polyacrylic acid, from 0.5 wt % to 20 wt % of an oxygen scavenger, from 0.5 wt % to 20 wt % of a corrosion inhibitor, from 0.5 wt % to 40 wt % of a calcium group salt, from 0.5 wt % to 20 wt % of a copper salt, and optionally, from 0.5 wt % to 20 wt % of a viscosity enhancer.

Embodiment 19. The system of Embodiment 17 or 18, wherein the crosslinked polyacrylic acid comprises a crosslinked reaction product of a first precursor fluid and a second precursor fluid.

Embodiment 20. The system of Embodiment 19, wherein the first precursor fluid comprises, by total volume of the first precursor fluid: from 25 vol % to 50 vol % of polyacrylic acid, from 1 vol % to 10 vol % of an oxygen scavenger, from 5 vol % to 15 vol % of a corrosion inhibitor, and a balance of water.

Embodiment 21. The system of Embodiment 19, wherein the second precursor fluid comprises, by total volume of the second precursor fluid: from 1 vol % to 10 vol % of an oxygen scavenger, from 5 vol % to 15 vol % of a corrosion inhibitor, from 25 vol % to 60 vol % of a calcium group salt, from 1 vol % to 20 vol % of a copper salt, and a balance of water.

Embodiment 22. The system of any one of Embodiments 17-21, wherein the polymeric gel pack further comprises sand.

Embodiment 23. The system of any one of Embodiments 17-22, wherein the polymeric gel pack is a layer in contact with the pipeline.

The terminology used herein is for the purpose of describing particular embodiments only and is not intended to be limiting of the invention. As used herein, for example, the singular forms “a,” “an,” and “the” are intended to include the plural forms as well, unless the context clearly indicates otherwise. It will be further understood that the terms “contains,” “containing.” “includes.” “including,” “comprises.” and/or “comprising,” and variations thereof, when used in this specification, specify the presence of stated features, integers, steps, operations, elements, and/or components, but do not preclude the presence or addition of one or more other features, integers, steps, operations, elements, components, and/or groups thereof.

Terms of orientation used herein are merely for purposes of convention and referencing and are not to be construed as limiting. However, it is recognized these terms could be used with reference to an operator or user. Accordingly, no limitations are implied or to be inferred. In addition, the use of ordinal numbers (e.g., first, second, third, etc.) is for distinction and not counting. For example, the use of “third” does not imply there must be a corresponding “first” or “second.” Also, if used herein, the terms “coupled” or “coupled to” or “connected” or “connected to” or “attached” or “attached to” may indicate establishing either a direct or indirect connection, and is not limited to either unless expressly referenced as such.

While the disclosure has described several exemplary embodiments, it will be understood by those skilled in the art that various changes can be made, and equivalents can be substituted for elements thereof, without departing from the spirit and scope of the invention. In addition, many modifications will be appreciated by those skilled in the art to adapt a particular instrument, situation, or material to embodiments of the disclosure without departing from the essential scope thereof. Therefore, it is intended that the invention not be limited to the particular embodiments disclosed, or to the best mode contemplated for carrying out this invention, but that the invention will include all embodiments falling within the scope of the appended claims. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative.

What is claimed is:

1. A method comprising:
applying a polymeric gel pack comprising a polymeric gel to a pipeline, wherein a first precursor fluid and a second precursor fluid react to form the polymeric gel, wherein the polymeric gel pack at least partially surrounds the pipeline, wherein the first precursor fluid comprises, by total volume of the first precursor fluid:
from 25 vol % to 50 vol % of polyacrylic acid,
from 1 vol % to 10 vol % of an oxygen scavenger,
from 5 vol % to 15 vol % of a corrosion inhibitor, and a balance of water; and
wherein the second precursor fluid comprises, by total volume of the second precursor fluid:
from 1 vol % to 10 vol % of an oxygen scavenger,
from 5 vol % to 15 vol % of a corrosion inhibitor,
from 25 vol % to 60 vol % of a calcium group salt,
from 1 vol % to 20 vol % of a copper salt, and a balance of water.

2. A method comprising:
applying a polymeric gel pack comprising a polymeric gel to a pipeline, wherein a first precursor fluid and a second precursor fluid react to form the polymeric gel, and wherein the polymeric gel pack at least partially surrounds the pipeline.

3. The method of claim 2, wherein the first precursor fluid and the second precursor fluid are applied to sand surrounding the pipeline.

4. The method of claim 2, wherein applying the polymeric gel pack comprises applying the first precursor fluid and the second precursor fluid directly to the pipeline so as to form the polymeric gel pack as a layer on the pipeline.

5. The method of claim 2, wherein applying the polymeric gel pack comprises spraying the first precursor fluid and the second precursor fluid surrounding the pipeline.

6. The method of claim 2, wherein the first precursor fluid comprises, by total volume of the first precursor fluid:
from 25 vol % to 50 vol % of polyacrylic acid,
from 1 vol % to 10 vol % of an oxygen scavenger,
from 5 vol % to 15 vol % of a corrosion inhibitor, and
a balance of water.

7. The method of claim 6, wherein the oxygen scavenger is provided as a first aqueous solution having a first concentration of the oxygen scavenger from 1.0 mol/L to saturated, and wherein the corrosion inhibitor is provided as a second aqueous solution having a second concentration of the corrosion inhibitor from 1.0 mol/L to saturated.

8. The method of claim 6, wherein the oxygen scavenger comprises sodium sulfite, cobalt sulfate, sodium bisulfite, hydrazine, carbohydrazide, or any combination thereof, or a combination thereof, and wherein the corrosion inhibitor comprises a quaternary ammonium compound, alkyldimethylbenzylammonium chloride, ammonium bisulfite, an alcohol, or any combination thereof.

9. The method of claim 6, wherein the first precursor fluid further comprises, by total volume of the first precursor fluid, from 1 vol % to 10 vol %, of a viscosity enhancer.

10. The method of claim 9, wherein the viscosity enhancer comprises a solution of carboxymethyl hydroxypropyl guar (CMHPG), hydroxypropyl guar (HPG), carboxymethylhydroxypropyl guar (CMHPG), guar, carboxymethyl guar (CMG), derivatized guar, carboxymethyl cellulose, carboxymethyl hydroxyl propyl cellulose, cellulose derivatives, or any combination thereof, and wherein a concertation of the viscosity enhancer in the solution is from 1.0 mol/L to saturated.

11. The method of claim 6, wherein the first precursor fluid further comprises sodium hydroxide, sodium carbonate, or a combination.

12. The method of claim 2, wherein the pH of the first precursor fluid is adjusted to be from 5.1 to 9.1.

13. The method of claim 2, wherein the second precursor fluid comprises, by total volume of the second precursor fluid:
from 1 vol % to 10 vol % of an oxygen scavenger,
from 5 vol % to 15 vol % of a corrosion inhibitor,
from 25 vol % to 60 vol % of a calcium group salt,
from 1 vol % to 20 vol % of a copper salt, and
a balance of water.

14. The method of claim 13, wherein the copper salt comprises a solution of copper(II) chloride, copper(II) sulfate, copper(II) nitrate, or any combination thereof, and wherein the solution has a concentration of the copper salt from 1.0 mol/L to saturated.

15. The method of claim 13, wherein the calcium group salt comprises a solution of calcium chloride, calcium bromide, calcium iodide, magnesium chloride, or any combination thereof, and wherein the solution has a concentration of the calcium group salt from 1.0 mol/L to saturated.

16. The method of claim 2, wherein the polymeric gel pack further comprises sand.

17. A system comprising:
a pipeline; and
a polymeric gel pack comprising a polymeric gel, wherein the polymeric gel pack at least partially surrounds the pipeline, and wherein the polymeric gel comprises polyacrylic acid, wherein the polyacrylic acid has been, at least partially, crosslinked.

18. The system of claim 17, wherein the polymeric gel comprises, by weight of the polymeric gel:
from 20 wt % to 95 wt % of the polyacrylic acid,
from 0.5 wt % to 20 wt % of an oxygen scavenger,
from 0.5 wt % to 20 wt % of a corrosion inhibitor,
from 0.5 wt % to 40 wt % of a calcium group salt,
from 0.5 wt % to 20 wt % of a copper salt, and optionally, from 0.5 wt % to 20 wt % of a viscosity enhancer.

19. The system of claim 17, wherein the crosslinked polyacrylic acid comprises a crosslinked reaction product of a first precursor fluid and a second precursor fluid.

20. The system of claim 19, wherein the first precursor fluid comprises, by total volume of the first precursor fluid:
from 25 vol % to 50 vol % of polyacrylic acid,
from 1 vol % to 10 vol % of an oxygen scavenger,
from 5 vol % to 15 vol % of a corrosion inhibitor, and
a balance of water; and
wherein the second precursor fluid comprises, by total volume of the second precursor fluid:
from 1 vol % to 10 vol % of an oxygen scavenger,
from 5 vol % to 15 vol % of a corrosion inhibitor,
from 25 vol % to 60 vol % of a calcium group salt,
from 1 vol % to 20 vol % of a copper salt, and
a balance of water.
